(19) United States
(12) Patent Application Publication
(10) Pub. No.: US 2024/0399652 A1
(43) Pub. Date: Dec. 5, 2024

(54) THREE-DIMENSIONAL PRINTING WITH PHOTOSENSITIVE RESIN

(71) Applicant: International Business Machines Corporation, Armonk, NY (US)

(72) Inventors: Jeremy R. Fox, Georgetown, TX (US); Atul Mene, Morrisville, NC (US); Tushar Agrawal, West Fargo, ND (US); Sarbajit K. Rakshit, Kolkata (IN)

(21) Appl. No.: 18/328,079

(22) Filed: Jun. 2, 2023

(51) Int. Cl. B29C 64/118; B29C 64/209; B29C 64/264; B29C 64/393; B33Y 10/00; B33Y 30/00; B33Y 50/02

(52) U.S. Cl. CPC B29C 64/118; B29C 64/209; B29C 64/264; B29C 64/393; B33Y 10/00; B33Y 30/00; B33Y 50/02

(57) ABSTRACT

A system for three-dimensional (3D) printing. The system includes: a printing head for printing a material including a photosensitive resin; a first ultraviolet (UV) light source; and, a controller configured to direct the printing head to print a layer of the material, calculate an appropriate strength of UV radiation in a first UV beam to solidify the layer, and direct the first UV light source to project the first UV beam at the appropriate strength to the layer, wherein the printing head includes a semitransparent nozzle configured to allow the first UV beam to be transmitted through the semitransparent nozzle.

### BACKGROUND

The present disclosure relates generally to three-dimensional (3D) printing, and more specifically, to a method and system of 3D printing with photosensitive resin.

A 3D printing process, also known as additive manufacturing, builds a 3D printed object from a computer-aided design (CAD) model, usually by successfully adding material layer-by-layer. The layers can each be cured, for example, via exposure to UV light, solidifying them into a solid material matching the CAD model.

### SUMMARY

According to some embodiments of the disclosure, there is provided a system for three-dimensional (3D) printing. The system includes: a printing head for printing a material including a photosensitive resin; a first ultraviolet (UV) light source; and, a controller configured to direct the printing head to print a layer of the material, calculate an appropriate strength of UV radiation in a first UV beam to solidify the layer, and direct the first UV light source to project the first UV beam at the appropriate strength to the layer, wherein the printing head includes a semitransparent nozzle configured to allow the first UV beam to be transmitted through the semitransparent nozzle.

According to some embodiments of the disclosure, there is provided a system for 3D printing. The system includes a printing head that includes a semitransparent nozzle through which the material moves and is laid on a substrate wherein the printing head is adapted for printing a material including a photosensitive resin. The system also includes a first UV light source adapted to direct a first UV beam towards the semitransparent nozzle. The system further includes a second UV light source adapted to direct a second UV beam towards the substrate. The system additionally includes a controller. The controller is configured to: direct the printing head to print a layer of the material; calculate an appropriate strength of UV radiation in the first UV beam to increase the viscosity of the material as it moves through the semitransparent nozzle; direct the first UV light source to project the first UV beam at the appropriate strength to increase the viscosity of the material as it moves through the semitransparent nozzle; calculate an appropriate strength of UV radiation in the second UV beam to solidify the layer of the material as it is laid on the substrate; and direct the second UV light source to project the second UV beam at the appropriate strength to solidify the layer of the material as it is laid on the substrate.

According to some embodiments of the disclosure, there is provided a method of 3D printing with a material including a photosensitive resin. The method includes an operation of providing a 3D printing system. The 3D printing system includes: a printing head for printing a material including a photosensitive resin; a first UV light source; and, a controller configured to direct the printing head to print a layer of the material, calculate an appropriate strength of UV radiation in a first UV beam to solidify the layer, and direct the first UV light source to project the first UV beam at the appropriate strength to the layer, wherein the printing head includes a semitransparent nozzle configured to allow the first UV beam to be transmitted through the semitransparent nozzle. The method also includes an operation of projecting the first UV beam on the material including the photosensitive resin as it moves through the semitransparent nozzle. The method further includes an operation of printing a layer of the material including the photosensitive resin from the printing head through the semitransparent nozzle and onto a substrate.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a system for 3D printing using a photosensitive resin, according to illustrative embodiments.

FIG. 2 is a flow diagram of a method of 3D printing with photosensitive resin, in accordance with illustrative embodiments.

FIG. 3 is a flow chart of a method of 3D printing with photosensitive resin, according to some embodiments of the disclosure.

FIG. 4 is a computing environment that contains an example of an environment for the execution of at least some of the computer code involved in performing the inventive methods, according to some embodiments of the disclosure.

FIG. 5 is a 3D printing defect correction module as in FIG. 4, in accordance with some embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to three-dimensional (3D) printing, and more specifically, to a method and system of 3D printing with photosensitive resin.

A photopolymer, or light-activated resin, is a polymer that changes its properties when exposed to light, often in the ultraviolet (UV) or visible region of the electromagnetic spectrum. These changes are often manifested structurally. For example, a photopolymer can harden as a result of cross-linking when exposed to light.

A wide variety of technologically useful applications rely on photopolymers, with some examples being enamels and varnishes that depend upon a photopolymer formation for proper hardening upon exposure to light. In some instances, an enamel can cure in a fraction of a second when exposed to light, as opposed to thermally cured enamels that can require about a half of an hour or longer to cure. Curable materials are widely used for medical, printing and photoresist technologies. A mixture of curable materials (e.g., monomers, oligomers, and photo-initiators) can harden into a polymeric materials through a process called “photo-curing.”

Changes in structural and chemical properties can be induced internally by chromophores that the polymer subunit already possesses, or externally by addition of photosensitive molecules. A photopolymer can consist of a mixture of multifunctional monomers and oligomers in order to achieve desired physical properties. A wide variety of monomers and oligomers have been developed that can polymerize in the presence of light either though internal or external initiation. Photopolymers undergo the process called “photo-curing,” where oligomers are cross-linked upon exposure to light. The result of photo-curing is the formation of a thermoset network of polymers. One of the advantages of photo-curing is that it can be done selectively using high energy light sources, such as, for example, lasers. Some combination of monomers and oligomers may not be readily activated by light, and in such a case a photo-initiator is required. Photo-initiators are compounds that upon being radiated by light can decompose into reactive species that activate polymerization of specific functional groups on the oligomers, for example.

Different types of materials are currently used for 3D printing of different, final 3D printed objects. Light-based holographic objects can be projected onto photosensitive resin in order to manufacture a 3D printed object, for example. However, light-based holographic objects may not be created in some cases. Therefore, a need exists for other computation systems and/or infrastructure systems that can manufacture a 3D printed object using a photosensitive resin.

One advantage of the disclosed method and system of 3D printing using a photosensitive resin is that the method and system allows for control of photocuring of a 3D printed object. The photocuring can be controlled by changing a strength and/or a location of a light source or light sources used for photocuring, and can be controlled by changing a speed of printing. The disclosed method and system can include two light sources for curing purposes that can cure the 3D printed object, or layers thereof, in a two-step irradiation process. The disclosed method and system can also be used in order to repair a 3D printed object.

Disclosed is a method and system of 3D printing using a photosensitive resin as a filler material. While the resin is being used for printing, the proposed method and system can apply an appropriate strength of at least one beam of UV light, for example, that is required for solidification of the photosensitive resin.

Disclosed embodiments can use a photosensitive resin as a filler material, and along with a rate of laying the photosensitive resin filler, the system can calculate an appropriate strength of UV light beam(s) that will be projected on the photosensitive resin as it is being laid. The UV light beam(s) can be used to solidify the photosensitive resin filler to create layers of a 3D printed object.

Disclosed embodiments can be based on historical learning. For example, the system can calculate an optimum speed of laying the photosensitive resin filter material for any given strength of UV light beam radiation. While performing 3D printing with photosensitive resin filler, the system can select appropriate UV light beam strength.

Disclosed embodiments involve 3D printing of predetermined shape and dimension of a 3D printed object. Direction of laying the photosensitive resin filter is determined, and a robotic arm, for example, can be used to move a UV light source in order to focus UV light beams at a target location. A 3D printing nozzle can be aligned with the UV light beams. The photosensitive resin filler can be solidified using the UV light beams.

Disclosed embodiments can include management of a fluidity level of the photosensitive resin filler used to print a 3D printed object. The system can use a semitransparent nozzle and a controlled first UV light beam can be applied on the semitransparent nozzle in order to make the photosensitive resin filler become semi-solid with moving through the semitransparent nozzle. A controlled second UV light beam can be applied for final solidification of the photosensitive resin filler to construct a final 3D printed object.

Disclosed embodiments can include UV light management in order for photocuring of a 3D printed object. The UV light beam strength of two UV light beams used in the photo-curing process can be controlled. Also, a coverage area for the UV light beam exposure to the photosensitive resin can be controlled. The UV light beam strength can be dependent on the type of photosensitive resin, a level of fluidity of the photosensitive resin, a viscosity of the photosensitive resin, and other properties of the photosensitive resin. The system can use an appropriate UV light beam strength and coverage area of the UV light beam exposure so that optimum power consumption of the photosensitive resin can be used during 3D printing.

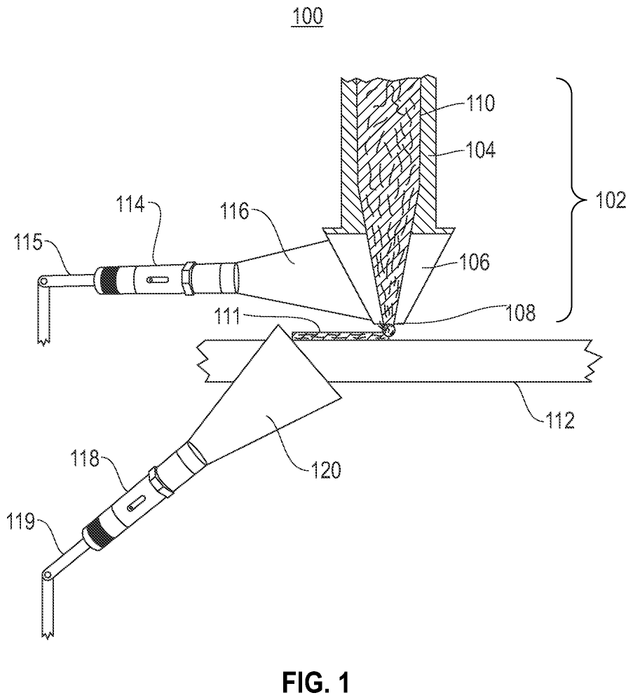

FIG. 1 is a system 100 for 3D printing using a photosensitive resin, according to illustrative embodiments. The figure shows an example nozzle portion 102 of a 3D printer. The nozzle portion 102 includes a nozzle body 104 and a semitransparent nozzle 106 (the semitransparent nozzle 106 can be any amount of transparent from at least partially transparent to completely transparent) with a nozzle opening 108. Photosensitive resin 110 is shown flowing though the nozzle portion 102 for 3D printing, and is shown being deposited as a layer 111 on a substrate 112. A first light source 114 is shown focusing a first beam of light 116 on the semitransparent nozzle 106, which can begin to solidify the photosensitive resin 110 as it exits the nozzle opening 108. The first light source 114 is shown connected to a first robotic arm 115 that can move the first light source 114 in order to focus the first beam of light 116 as desired. A second light source 118 is also shown focusing a second beam of light 120 on the photosensitive resin 110 after the layer 111 of the photosensitive resin 110 is laid on the substrate 112, in order to result in a final solidification of the layer 111. The second light source 118 is shown connected to a second robotic arm 119 that can move the second light source 118 in order to focus the second beam of light 120 as desired.

The first and second robotic arms 115, 119 are examples of methods of moving the first and second light sources 114, 118. As an alternative, the first and second light sources 114, 118 can be attached to arms that can be manually moved by an operator, for example. Other suitable devices for holding and moving the first and second light sources 114, 118 are also contemplated.

The semitransparent nozzle 106 can be made of a material that allows light, such as UV light, to be transmitted therethrough. Some examples of such a material include, but are not limited to transparent aluminum. Transparent aluminum is a transparent ceramic of polycrystalline aluminum oxynitride. Transparent aluminum is strong and has a high melting point (e.g., 1200 degrees Celsius). Thus, transparent aluminum can be used for products that need to withstand high heat and that need to be transparent or semitransparent nozzle 106 of the present disclosure. Other suitable materials for the semitransparent nozzle 106 are also contemplated.

The photosensitive resin 110 can be any material that can be solidified or cured when being exposed to light, such as UV light. Some examples of such a material include, but are not limited to polycarbonate, polylactic acid (PLA), acrylonitrile butadiene styrene (ABS), nylon, polyethylene terephthalate (PET), polyphenylsulfone (PPSU), carbon fiber filament, polyvinyl alcohol (PVA), high-density polyethylene (HDPE), polypropylene (PP), thermoplastic polyurethane (TPU), acrylonitrile styrene acrylate (ASA), polymethyl methacrylate (PMMA), and polyetherimide (PEI), for example. Other suitable materials for the photosensitive resins 110 are also contemplated.

The first and second light sources 114, 118 can emit a light beam. The wavelength of the light emitted by the first and second light sources 114, 118 is dependent on the photosensitive resin 110 used. For example, when a UV resin is selected as the photosensitive resin 110, a light beam can be violet light to UV light, and the wavelength thereof is below 430 nm, such as 400-405 nm.

After receiving a certain amount of light irradiation, the photosensitive resin 110 can be cured within a certain time, and this time is called “curing time.” The power (P) of light irradiation, i.e., light irradiation energy received by the photosensitive resin 110 per unit time (t), will significantly influence the curing time. In theory, the energy (W) required for curing a certain area of photosensitive resin 110 can be represented as:

$$W = P * t \qquad ( 1 )$$

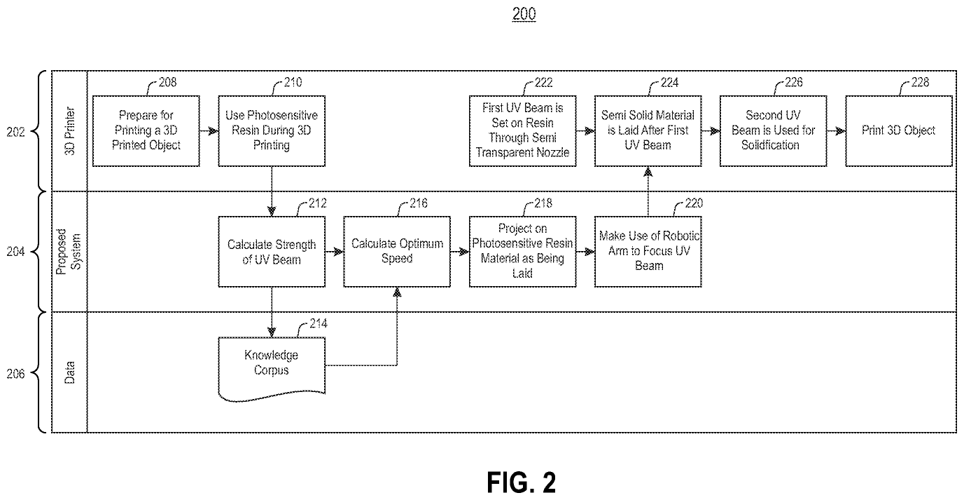

FIG. 2 is a flow diagram of a method 200 of 3D printing with photosensitive resin (such as 110 in FIG. 1), in accordance with illustrative embodiments. The method 200 can include operations carried out by a 3D printer (included in a 3D printer row 202 of the flow diagram of FIG. 2), a proposed system (included in a proposed system row 204 of the flow diagram of FIG. 2), or data (included in a data row 206 of the flow diagram of FIG. 2).

An operation 208 in the 3D printer row 202 is to prepare for printing a 3D printed object. This can include preparing for the 3D printing process to build the 3D printed object from a CAD model, for example. Another operation 210 in the 3D printer row 202 can be to use photosensitive resin 110, such as those described above with regard to FIG. 1, during 3D printing. The photosensitive resin 110 can be used as a filler material with other materials for 3D printing.

During 3D printing, a proposed system can include a computing device and/or software (otherwise referred to as a “controller”) that can perform an operation 212 of calculating appropriate strengths of a first UV beam (such as 116 in FIG. 1) and a second UV beam (such as 120 in FIG. 1). The first and second UV beams 116, 120 can be directed onto the photosensitive resin 110 as it is being laid from a first UV light source (such as 114 in FIG. 1) and a second UV light source (such as 118 in FIG. 1), respectively, which can solidify or cure the photosensitive resin 110. The system, while performing 3D printing, can select the appropriate UV beam strengths from the first and second UV light sources 114, 118. The calculation of the appropriate strengths of the UV beams 116, 120 can be communicated to a knowledge corpus in an operation 214 that appears in the data row 206 of the flow diagram. The knowledge corpus, or historical learning, can be used to calculate the strength of the UV beams 116, 120. In addition, other factors can be used to calculate the strength of the UV beams 116, 120, which can include type of photosensitive resin 110, a fluidity level of the photosensitive resin 110, a viscosity of the photosensitive resin 110, and other properties relating to the photosensitive resin 110. The appropriate UV beam strength and the appropriate coverage area for the UV beams 116, 120 can be determined in order to have optimum power consumption by the photosensitive resin 110.

In another operation 216, the computing device and/or software can calculate an optimum speed or rate of laying down the photosensitive resin 110 for any given strength of the UV beam radiation. The optimum speed or rate can be determined using the knowledge corpus (i.e., historical learning) operation 214. The system can then communicates with the first and second UV light sources 114, 118, in an operation 218, to project the first and second UV beams 116, 120 on the photosensitive resin 110 as it is being laid. The system can also include an operation 220 of making use of a first robotic arm (such as 115 in FIG. 1) and/or a second robotic arm (such as 119 in FIG. 1) attached to the first and/or second UV light sources 114, 118, respectively, in order to focus the UV beams 116, 120 from the first and second light sources 114, 118 onto the photosensitive resin 110 as it is being laid, for example. Based on the shape or dimension of a 3D printed object that is to be printed, a direction in which the photosensitive layer is laid can affect a position of the first and second robotic arms 115, 119 as well as the direction in which the first and second robotic arms 115, 119 can focus the UV beams 116, 120 at a desired target location.

The 3D printer row 202 of the flow diagram includes an operation 222 in which the first UV beam 116 from the first UV light source 114 is focused on the photosensitive resin 110 as it moves through a semitransparent nozzle (such as 106 in FIG. 1) of the 3D printer. The photosensitive resin 110, as it moves through the semitransparent nozzle 106, and is irradiated, can become a semi-solid in order to retain its structure. In another operation 226, the second UV beam 120 can be directed at the photosensitive resin 110 as it is being laid on a substrate (such as 112 in FIG. 1) (or as it is being laid on a prior layer of photosensitive resin 110) and can be used for solidification in order to construct a final 3D printed object. The operations described above can be repeated for a plurality of layers of photosensitive resin 110 that can form or print the final 3D printed object, as in operation 228.

The system can use the photosensitive resin 110 as a filler material and can calculate an appropriate strength of UV beam, and can project the UV beams 116, 120 as the photosensitive resin 110 is laid on a 3D printed object to repair or fill in order to solidify within an appropriate time. The system can leverage historical data to calculate optimal speed of laying the photosensitive resin 110 based on a given UV beam strength. The system can also recommend the strength of UV beams 116, 120 that should be used to lay the material at an appropriate speed. The system can leverage robotic arms 115, 119 to control an orientation of the 3D printed object, and can focus the UV beams 116, 120 on the object in alignment with the 3D printer's nozzle 102 at a target location. The system can control the first UV beam 116 applied to layers of the photosensitive resin 110 to control the viscosity of the photosensitive resin 110, and the second UV beam 120 can be used for the final solidification to construct the 3D printed object. The system can continuously build/update the knowledge corpus in order to track the strength of the UV beam or beams 116, 120 required to maintain the viscosity and the final solidification, such that the data can be used for recommendation and optimizing the power consumption.

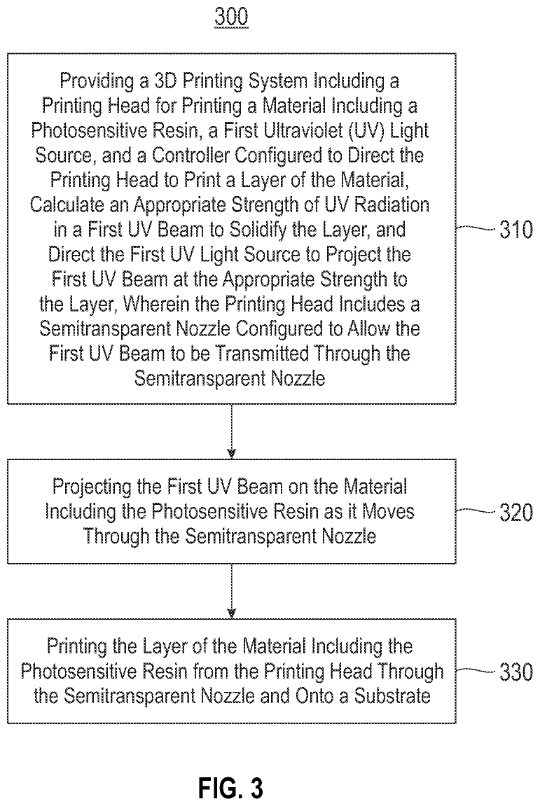

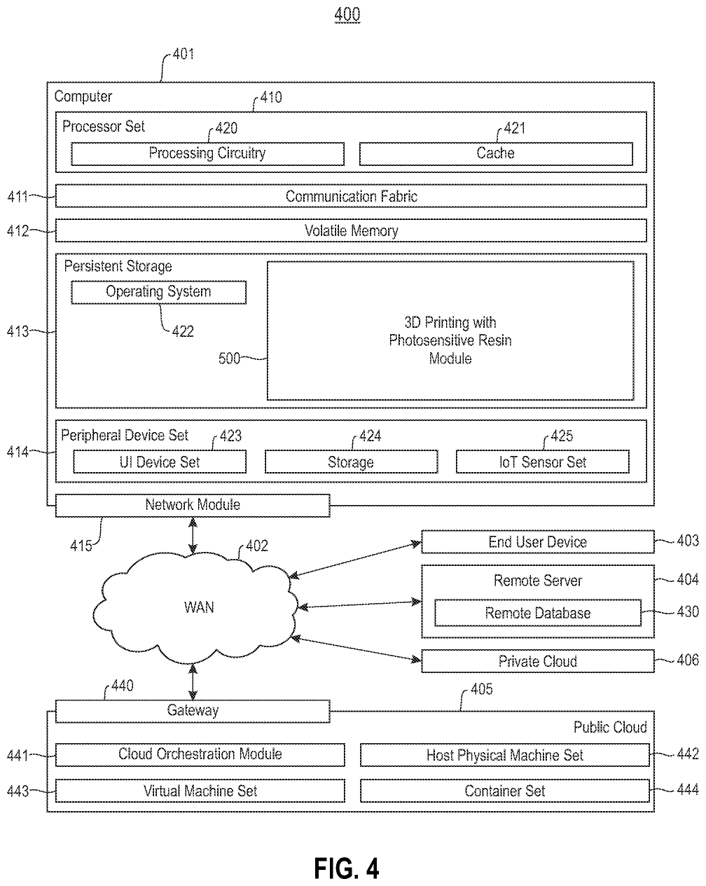

FIG. 3 is a flow chart of a method 300 of 3D printing with a material including a photosensitive resin (such as 110 in FIG. 1), according to some embodiments of the disclosure. One operation 310 is providing a 3D printing system (such as 100 in FIG. 1) including a printing head (such as 102 in FIG. 1) for printing a material including a photosensitive resin (such as 110 in FIG. 1), a first UV light source (such as 114 in FIG. 1), and a controller (such as computer 410 in FIG. 4, described below) configured to direct the printing head 102 to print a layer of the material (such as 111 in FIG. 1), calculate an appropriate strength of UV radiation in a first UV beam (such as 116 in FIG. 1) to solidify the layer 111, and direct the first UV light source 114 to project the first UV beam 116 at the appropriate strength to the layer 111, wherein the printing head 102 includes a semitransparent nozzle (such as 106 in FIG. 1) configured to allow the first UV beam 116 to be transmitted through the semitransparent nozzle 106. Another operation 320 is projecting the first UV beam 116 on the material including the photosensitive resin 110 as it moves through the semitransparent nozzle 106. Yet another operation 330 is printing the layer 111 of the material including the photosensitive resin 110 from the printing head 102 through the semitransparent nozzle 106 and onto a substrate (such as 112 in FIG. 1).

In the method 300 (although not shown in FIG. 3), the 3D printing system 100 can further comprise a second UV light source (such as 118 in FIG. 1), and the controller 401 can be further configured to calculate an appropriate strength of UV radiation in a second UV beam (such as 120 in FIG. 1) to solidify the layer 111, and can direct the second UV light source 118 to project the second UV beam 120 at the appropriate strength to the layer 111. An additional operation of the method 300 can then include projecting the second UV beam 120 from the second UV light source 118 on the layer 111 as it is printed on the substrate 112.

In the method 300 (although not shown in FIG. 3), the 3D printing system 100 can further comprise a first robotic arm (such as 115 in FIG. 1) connected to the first UV light source 114, and the controller 401 can be further configured to direct the first robotic arm 115 to move the first UV light source 114. An additional operation of the method 300 can then include moving the first robotic arm 115 to focus the first UV beam 116 on the semitransparent nozzle 106. Also, in the method 300, the 3D printing system 100 can further comprise a second robotic arm (such as 119 in FIG. 1) connected to the second UV light source 118, and the controller 401 can be further configured to direct the second robotic arm 119 to move the second UV light source 118. An additional operation of the method 300 can then include moving the second robotic arm 119 to focus the second UV beam 120 on the layer 111 as it is printed on the substrate 112.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As shown in FIG. 4, a computing environment 400 contains an example of an environment for the execution of at least some of the computer code involved in performing the inventive methods, such as a 3D printing with photosensitive resin module 500, consistent with some embodiments. In addition to the 3D printing with photosensitive resin module 500, computing environment 400 includes, for example, computer 401, wide area network (WAN) 402, end user device (EUD) 403, remote server 604, public cloud 405, and private cloud 406. In this embodiment, computer 401 includes processor set 410 (including processing circuitry 420 and cache 421), communication fabric 411, volatile memory 412, persistent storage 413 (including operating system 422 and block 500, as identified above), peripheral device set 414 (including user interface (UI) device set 423, storage 424, and Internet of Things (IoT) sensor set 425), and network module 415. The EUD 403 can be a 3D printer, for example. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 500 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 500 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 601. For example, in a hypothetical case where computer 401 is designed and programmed to provide a recommendation based on historical data, then this historical data may be provided to computer 601 from remote database 630 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

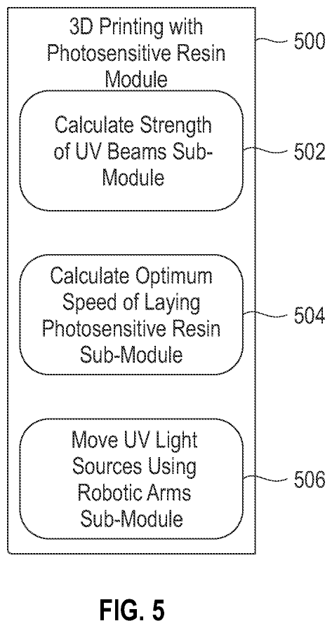

FIG. 5 is the 3D printing with photosensitive resin module 500 of FIG. 4, consistent with some embodiments. As shown, the 3D printing with photosensitive resin module 500 can include a sub-module to calculate strength of a first UV beam and/or a second UV beam, as illustrated by block 502. The 3D printing with photosensitive resin module 500 can also include a sub-module to calculate optimum speed of laying photosensitive resin, as illustrated by block 504. A further submodule that ca be included is to move UV light source(s) using robotic arm(s), which is connected to the UV light source(s), as illustrated by block 506.

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.”

“3D printer” is defined as “a machine used for 3D printing” and “3D printing” is defined as “the fabrication of objects through the deposition of a material using a printer (or print) head, nozzle, or another printer technology.”

Synonyms associated with and encompassed by 3D printing include additive fabrication, additive processes, additive techniques, additive layer manufacturing, layer manufacturing, and freeform fabrication. “Additive manufacturing (AM)” is defined as “a process of joining materials to make objects from 3D model data, usually layer upon layer, as opposed to subtractive manufacturing methodologies. Additive manufacturing (AM) may also be referred to as rapid prototyping (RP). As used herein, “3D printing” is generally interchangeable with “additive manufacturing” and vice versa.

“Printing” is defined as depositing of a material using a print head, nozzle, or another printer technology.

In this disclosure, “3D or three dimensional article, object or part” means an article, object or part obtained by additive manufacturing or 3D printing as disclosed above.

In this disclosure, the term “3D printing” covers a variety of processes in which material is joined or solidified under computer control to create a 3D object. Material is added together (such as liquid molecules or powder grains being fused together) such as layer-by-layer.

In general, all 3D printing processes have a common starting point, which is a computer generated data source or program which may describe an object. The computer generated data source or program can be based on an actual or virtual object. For example, an actual object can be scanned using a 3D scanner and scan data can be used to make the computer generated data source or program. Alternatively, the computer generated data source or program may be designed from scratch.

The computer generated data source or program can be converted into a standard tessellation language (STL) file format; however other file formats can also or additionally be used. The file is generally read into 3D printing software, which takes the file and optionally user input to separate it into hundreds, thousands, or even millions of “slices.” The 3D printing software can output machine instructions, which may be in the form of G-code, which is read by the 3D printer to build each slice. The machine instructions are transferred to the 3D printer, which then builds the object, layer-by-layer, based on this slice information in the form of machine instructions. Thicknesses of these slices may vary.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for three-dimensional (3D) printing, the system comprising:
a printing head for printing a material including a photosensitive resin;
a first ultraviolet (UV) light source; and
a controller configured to
direct the printing head to print a layer of the material,
calculate an appropriate strength of UV radiation in a first UV beam to solidify the layer, and
direct the first UV light source to project the first UV beam at the appropriate strength to the layer,
wherein the printing head includes a semitransparent nozzle configured to allow the first UV beam to be transmitted through the semitransparent nozzle.

2. The system of claim 1, wherein the controller is further configured to calculate an optimum speed of printing the layer based on the appropriate strength.

3. The system of claim 1, wherein the controller is further configured to apply the first UV beam to the semitransparent nozzle.

4. The system of claim 1, further comprising:
a second UV light source,
wherein the controller is configured to calculate an appropriate strength of UV radiation in a second UV beam to solidify the layer, and direct the second UV light source to project the second UV beam at the appropriate strength to the layer.

5. The system of claim 4, wherein the controller is further configured to apply the second UV beam to the layer as it is laid on a substrate.

6. The system of claim 4, further comprising:
a first robotic arm connected to the first UV light source, wherein the controller is further configured to direct the first robotic arm to move the first UV light source.

7. The system of claim 1, further comprising:
a first robotic arm connected to the first UV light source, wherein the controller is further configured to direct the first robotic arm to move the first UV light source.

8. The system of claim 7, further comprising:
a second robotic arm connected to the second UV light source, wherein the controller is further configured to direct the second robotic arm to move the second UV light source.

9. The system of claim 1, wherein the semitransparent nozzle is made of transparent aluminum.

10. A system for three-dimensional (3D) printing, the system comprising:
a printing head that includes a semitransparent nozzle through which the material moves and is laid on a substrate wherein the printing head is adapted for printing a material including a photosensitive resin;
a first ultraviolet (UV) light source adapted to direct a first UV beam towards the semitransparent nozzle;
a second UV light source adapted to direct a second UV beam towards the substrate; and
a controller configured to
direct the printing head to print a layer of the material,
calculate an appropriate strength of UV radiation in the first UV beam to increase the viscosity of the material as it moves through the semitransparent nozzle,
direct the first UV light source to project the first UV beam at the appropriate strength to increase the viscosity of the material as it moves through the semitransparent nozzle,
calculate an appropriate strength of UV radiation in the second UV beam to solidify the layer of the material as it is laid on the substrate, and
direct the second UV light source to project the second UV beam at the appropriate strength to solidify the layer of the material as it is laid on the substrate.

11. The system of claim 10, further comprising:
a first robotic arm connected to the first UV light source, wherein the controller is further configured to direct the first robotic arm to move the first UV light source.

12. The system of claim 11, further comprising:
a second robotic arm connected to the second UV light source, wherein the controller is further configured to direct the second robotic arm to move the second UV light source.

13. The system of claim 10, wherein the controller is further configured to calculate an optimum speed of printing the layer based on the appropriate strengths of the first UV beam and the second UV beam.

14. The system of claim 10, wherein the semitransparent nozzle is made of transparent aluminum.

15. A method of three-dimensional (3D) printing with a material including a photosensitive resin, the method comprising:
providing a 3D printing system including
a printing head for printing a material including a photosensitive resin,
a first ultraviolet (UV) light source, and
a controller configured to
direct the printing head to print a layer of the material,
calculate an appropriate strength of UV radiation in a first UV beam to solidify the layer, and
direct the first UV light source to project the first UV beam at the appropriate strength to the layer,
wherein the printing head includes a semitransparent nozzle configured to allow the first UV beam to be transmitted through the semitransparent nozzle;
projecting the first UV beam on the material including the photosensitive resin as it moves through the semitransparent nozzle; and
printing a layer of the material including the photosensitive resin from the printing head through the semitransparent nozzle and onto a substrate.

16. The method of claim 15, wherein the 3D printing system further comprises a second UV light source, and the controller is further configured to calculate an appropriate strength of UV radiation in a second UV beam to solidify the layer, and direct the second UV light source to project the second UV beam at the appropriate strength to the layer, and the method further comprises:
projecting the second UV beam from the second UV light source on the layer as it is printed on the substrate.

17. The method of claim 15, wherein the 3D printing system further comprises a first robotic arm connected to the first UV light source, and the controller is further configured to direct the first robotic arm to move the first UV light source, and the method further comprises:
moving the first robotic arm to focus the first UV beam on the semitransparent nozzle.

18. The method of claim 17, wherein the 3D printing system further comprises a second UV light source, and the controller is further configured to calculate an appropriate strength of UV radiation in a second UV beam to solidify the layer, and direct the second UV light source to project the second UV beam at the appropriate strength to the layer, and the method further comprises:
projecting a second UV beam from the second UV light source on the layer as it is printed on the substrate.

19. The method of claim 18, wherein the 3D printing system further comprises a second robotic arm connected to the second UV light source, and the controller is further configured to direct the second robotic arm to move the second UV light source, and the method further comprises:
moving the second robotic arm to focus the second UV beam on the layer as it is printed on the substrate.

20. The method of claim 15, wherein the controller is further configured to calculate an optimum speed of printing the layer based on the appropriate strength.
